(19) United States
(12) Patent Application Publication
(10) Pub. No.: US 2001/0003486 A1
(43) Pub. Date: Jun. 14, 2001

(54) Optical communication system and optical repeater used for same

(76) Inventor: Satoshi Mikami, Tokyo (JP)

Correspondence Address: MCGINN & GIBB, PLLC, 8321 OLD COURTHOUSE ROAD, SUITE 200, VIENNA, VA, 22182-3817, US

(21) Appl. No.: 09/730,786

(22) Filed: Dec. 7, 2000

(30) Foreign Application Priority Data
Dec. 8, 1999 (JP) 11-348262

(51) Int. Cl. H04B 10/00

(52) U.S. Cl. 359/161; 359/179

(57) ABSTRACT

An optical communication system is provided which is capable of easily calibrating a difference in outputs of each of wavelength-multiplexed optical signals.

An optical signal propagates through an optical transmission line and is amplified by an optical amplifier in an optical repeater and is sent as an amplified optical signal to another optical transmission line. A transmission line compensating device in the optical repeater, based on a control signal superimposed on the optical signal propagated through the optical transmission line, generates control light and sends it to the optical transmission line. A loss spectrum is compensated by the control light.

### BACKGROUND OF THE INVENTION

1. Field of the Invention

The present invention relates to an optical communication system and an optical repeater used for same and more particularly to a method for calibrating a difference in optical outputs of each of wavelength-multiplexed optical signals which is caused by a loss spectrum in a wavelength multiplexing optical communication system.

The present application claims priority of Japanese Patent Application No. Hei 11-348262 filed on Dec. 8, 1999, which is hereby incorporated by reference.

2. Description of the Related Art

In an optical communication system, a loss spectrum exhibited intrinsically by an optical transmission line exerts a great influence on optical signal characteristics and, in a wavelength multiplexing communication system in particular, the loss spectrum exhibited intrinsically by the optical transmission line causes a difference in outputs of each of wavelength-multiplexed optical signals each having a different wavelength.

Conventionally, when such the optical communication system is designed, in order to prevent optical signal characteristics from being affected by a Raman gain caused by a leak of pumping light emitted from an optical repeater and loss spectrum exhibited intrinsically by the optical transmission line, great consideration is given to these factors in particular.

However, as number of wavelength-multiplexed signals increase, it becomes difficult to properly calibrate a difference in outputs of each of wavelength-multiplexed optical signals only by an end terminal device of the optical transmission lines.

### SUMMARY OF THE INVENTION

In view of the above, it is an object of the present invention to provide an optical communication system capable of easily and properly calibrating a difference in outputs of each of wavelength-multiplexed signals and an optical repeater used for the optical communication system.

According to a first aspect of the present invention, there is provided an optical communication system for amplifying an optical signal propagating through an optical transmission line by using an optical amplifier in an optical repeater and emitting an amplified optical signal to an optical transmission line mounted at a back stage including:

a transmission line compensating device to generate control light for producing a Raman amplification effect within the optical transmission line based on a control signal superimposed on the optical signal.

In the foregoing, a preferable mode is one wherein the transmission line compensating device is so configured as to send the control light to an optical transmission line mounted at a front stage.

Also, a preferable mode is one wherein the transmission line compensating device is so configured as to send the control light to the optical transmission line mounted at the back stage.

Also, a preferable mode is one wherein the transmission line compensating device is mounted inside the optical repeater.

Also, a preferable mode is one wherein the transmission line compensating device is separately and individually outside the optical repeater.

Also, a preferable mode is one wherein the transmission line compensating device includes two or more control light sources to generate control light having a different wavelength and output and an optical multiplexer to multiplex the control light fed from the two or more control light sources.

According to a second aspect of the present invention, there is provided an optical communication system for amplifying an optical signal propagating through an upward transmission line or a downward transmission line by using a corresponding optical amplifier in an optical repeater and sending an amplified optical signal to an upward transmission line or a downward transmission line mounted at a back stage including:

transmission line compensating devices each operating for the upward transmission line or the downward transmission line and each generating, based on a control signal superimposed on the optical signal, control light which causes a Raman amplification effect in the optical transmission lines.

In the foregoing, a preferable mode is one wherein the transmission line compensating devices are so configured as to send the control light to optical transmission lines mounted at a front stage.

Also, a preferable mode is one wherein the transmission line compensating devices are so configured as to send the control light to optical transmission lines mounted at the back stage

Also, a preferable mode is one wherein the transmission line compensating devices are mounted inside the optical repeater.

Also, a preferable mode is one wherein the transmission line compensating devices are separately and individually mounted outside the optical repeater.

Also, a preferable mode is one wherein the transmission line compensating devices include two or more control light sources to generate control light having a different wavelength and output and an optical multiplexer to multiplex the control light fed from the two or more control light sources.

Also, a preferable mode is one that wherein includes common circuits each controlling simultaneously the transmission line compensating devices each operating to correspond to the upward transmission line or the downward transmission line.

According to a third aspect of the present invention, there is provided an optical repeater for amplifying an optical signal propagating through an optical transmission line by using an optical amplifier and sending an amplified optical signal to an optical transmission line mounted at a back stage including:

a transmission line compensating device to generate, based on a control signal superimposed on the optical signal, control light which produces a Raman amplification effect within the optical transmission line.

In the foregoing, it is preferable that the transmission line compensating device is so configured as to send the control light to an optical transmission line mounted at a front stage.

Also, it is preferable that the transmission line compensating device is so configured as to send the control light to an optical transmission line mounted at a back stage.

Also, it is preferable that the transmission line compensating device is mounted inside the optical repeater.

Also, it is preferable that the transmission line compensating device is separately and individually mounted outside the optical repeater.

Also, it is preferable that the transmission line compensating device includes two or more control sources to generate control light having a different wavelength and output and an optical multiplexer to multiplex the control light fed from the two or more control light sources.

According to a fourth aspect of the present invention, there is provided an optical repeater for amplifying an optical signal propagating through an upward transmission line or a downward transmission line by using a corresponding optical amplifier and sending an amplified optical signal to the upward transmission line mounted at a back stage or the downward transmission mounted at the back stage including:

transmission line compensating devices each operating for the upward transmission line or the downward transmission line and each generating, based on a control signal superimposed on the optical signal, control light which produces a Raman amplification effect within the upward transmission line or the downward transmission line.

In the foregoing, a preferable mode is one wherein the transmission line compensating device is so configured as to send the control light to an optical transmission line mounted at a front stage.

Also, a preferable mode is one wherein the transmission line compensating device is so configured as to send the control light to the optical transmission line mounted at the back stage.

Also, a preferable mode is one wherein the transmission line compensating device is mounted inside the optical repeater.

Also, a preferable mode is one wherein the transmission line compensating device is separately and individually mounted outside the optical repeater.

Also, a preferable mode is one wherein the transmission line compensating device includes two or more control sources to generate control light having a different wavelength and output and an optical multiplexer to multiplex the control light fed from the two or more control light sources.

Furthermore, a preferable mode is one that wherein includes common circuits each controlling simultaneously the transmission line compensating devices each operating to correspond to the upward transmission line or the downward transmission line.

With the above configurations as being provided with a transmission line compensating device adapted to generate, based on a control signal superimposed on the optical signal, control light which produces a Raman amplification effect in the optical transmission line, a difference in outputs of each of wavelength-multiplexed signals can be easily calibrated.

### BRIEF DESCRIPTION OF THE DRAWINGS

The above and other objects, advantages and features of the present invention will be more apparent from the following description taken in conjunction with the accompanying drawings in which:

FIG. 1 is a schematic block diagram showing configurations of an optical communication system according to a first embodiment of the present invention;

FIG. 2 is a schematic block diagram showing detailed configurations of an optical repeater shown in FIG. 1;

FIG. 3 is a diagram explaining effects obtained by the present invention;

FIG. 4 is a schematic block diagram showing detailed configurations of an optical repeater according to a second embodiment of the present invention;

FIG. 5 is a schematic block diagram showing detailed configurations of a transmission line compensating device according to a third embodiment of the present invention;

FIG. 6 is a schematic block diagram showing configurations of an optical communication system according to a fourth embodiment of the present invention;

FIG. 7 is a schematic block diagram showing detailed configurations of an optical repeater according to a fifth embodiment of the present invention; and

FIG. 8 is a schematic block diagram showing detailed configurations of an optical repeater according to a sixth embodiment of the present invention.

### DETAILED DESCRIPTION OF THE PREFERRED EMBODIMENTS

Best modes of carrying out the present invention will be described in further detail using various embodiments with reference to the accompanying drawings.

### First Embodiment

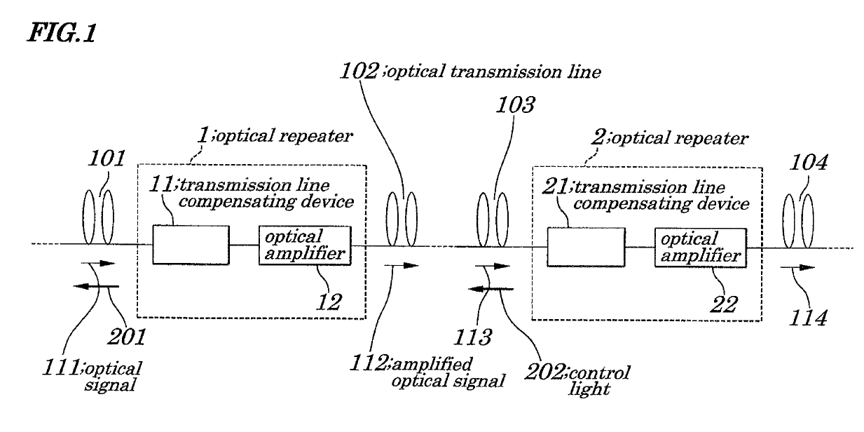

FIG. 1 is a schematic block diagram showing configurations of an optical communication system according to a first embodiment of the present invention. As shown in FIG. 1, in the optical communication system of the first embodiment, between an optical transmission line 101 and an optical transmission line 102 is disposed an optical repeater 1 and between an optical transmission line 103 and an optical transmission line 104 is disposed an optical repeater 2. The optical repeater 1 is composed of a transmission line compensating device 11 and an optical amplifier 12. The optical repeater 2 is composed of a transmission line compensating device 21 and an optical amplifier 22. An optical signal 111 propagates through the optical transmission line 101 and is then amplified by the optical amplifier 12 in the optical repeater 1 and further propagates, as an amplified optical signal 112, through the optical transmission line 102. An optical signal 113 propagates through the optical transmission line 103 and is then amplified by the optical amplifier 22 in the optical repeater 2 and further propagates as an amplified optical signal 114, through the optical transmission line 104. The transmission line compensating device 11 in the optical repeater 1 emits control light 201, based on a control signal superimposed on the optical signal 111, to the optical transmission line 101. The transmission line compensating device 21 in the optical repeater 2 emits control light 202, based on a control signal superimposed on the optical signal 113, to the optical transmission line 103. By the control light 201 causes a Raman amplification effect in the optical transmission line 101 causing a loss spectrum exhibited intrinsically by the optical transmission line 101 to be compensated in a wavelength band of the optical signal 111. Similarly, by the control light 202 causes a Raman amplification effect in the optical transmission line 103 causing a loss spectrum exhibited intrinsically by the optical transmission line 103 to be compensated in a wavelength band of the optical signal 113.

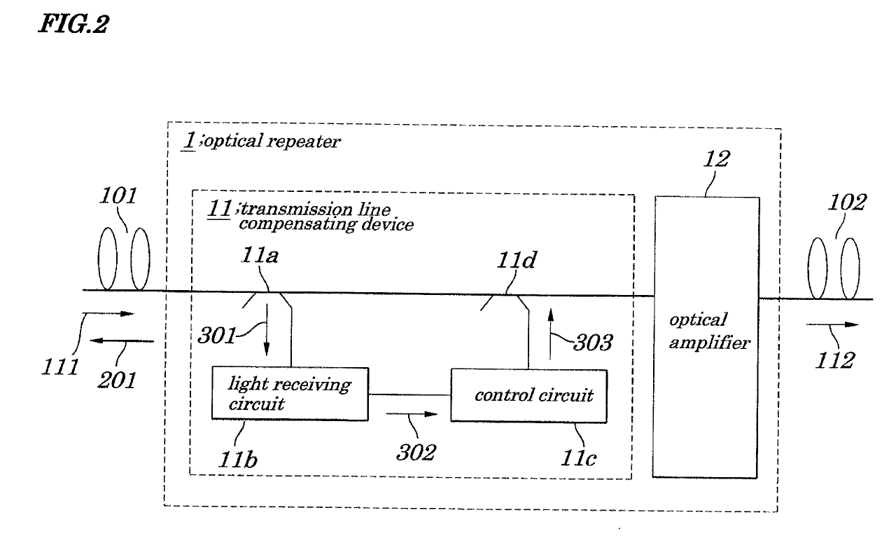

FIG. 2 is a schematic block diagram showing detailed configurations of the optical repeater 1 shown in FIG. 1. As shown in FIG. 2, the optical repeater 1 is composed of the transmission line compensating device 11 and the optical amplifier 12. The transmission line compensating device 11 has an optical branching circuit 11a, a light receiving circuit 11b, a control circuit 11c and an optical multiplexer 11d. A part of the optical signal 111 propagating through the optical transmission line 101 is branched by the optical branching circuit 11a and a branched optical signal 301 is received by the light receiving circuit 11b.

On the branched optical signal 301 is superimposed a control signal 302 which controls operations of the control circuit 11c. The control circuit 11c emits a control light 303 in response to the control signal 302. The control light 303 is sent as the control light 201 by the optical multiplexer 11d in the transmission line compensating device 11. By the control light 201 causes a Raman amplification effect in the optical transmission line 101 causing a loss spectrum exhibited intrinsically by the optical transmission line 101 to be compensated in a wavelength band of the optical signal 111.

The control circuit 11c has a function of causing an optical output, wavelength or a like of the control light 201 to be changeable, which enables the loss spectrum exhibited intrinsically by the optical transmission line 101 to be compensated by the Raman amplification effect being produced while the control light 201 propagates through the optical transmission line 101.

As a result, by sending a control signal from an end terminal device (not shown) of the optical transmission lines, a loss spectrum exhibited by the optical transmission line can be controlled and calibration is made possible. In a wavelength multiplexing optical communication system in particular, a plurality of optical signals propagates simultaneously through a same optical transmission line and therefore, by using the method disclosed in the embodiment of the present invention, a loss spectrum exhibited by an optical transmission line can be adjusted properly so that levels of two or more optical signals are optimized. If an optical signal in a wavelength band of 1.55 μm is transmitted, by using, as control light, light in a wavelength band of 1.48 μm, a highly efficient Raman effect can be obtained.

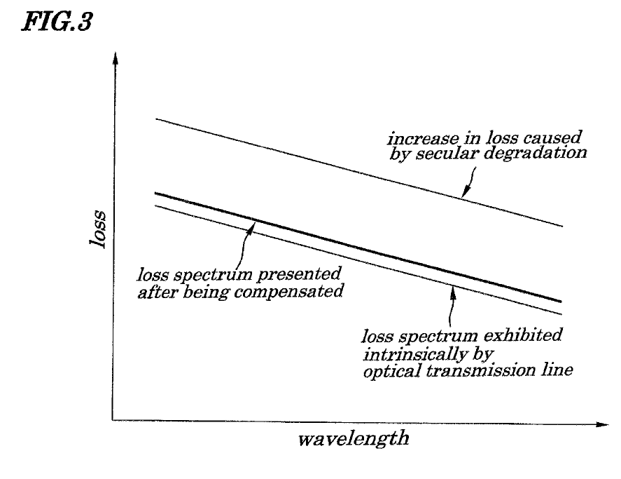

FIG. 3 is a diagram explaining effects obtained by the present invention. As shown in FIG. 3, an optical transmission line exhibits its own intrinsic loss spectrum. In the wavelength multiplexing optical communication, the loss spectrum causes a difference in outputs or a like among a plurality of optical signals each having a different wavelength. Moreover, it is known that a loss is increased by secular degradation of the optical transmission line itself and this also causes a degradation in the quality of a wavelength multiplexing optical communication system.

However, according to the present invention using Raman effect, a gain causes in the optical transmission line. This means that it is possible to change the loss in the optical transmission line. Moreover, since the gain changes depending on the loss spectrum, it is also possible to change a slope in the loss spectrum exhibited intrinsically by the optical transmission line.

Furthermore, by using the method of the present invention, the loss in the optical transmission line increased due to secular degradation of the optical transmission line itself can be compensated, thus preventing a degradation in the quality of the optical communication system.

As described above, according to the present invention, an output of an optical signal propagating from an end terminal device of an optical transmission line through the optical transmission line and a loss spectrum exhibited by the optical transmission can be properly controlled, thus enabling the optical transmission line of a high quality to be implemented.

### Second Embodiment

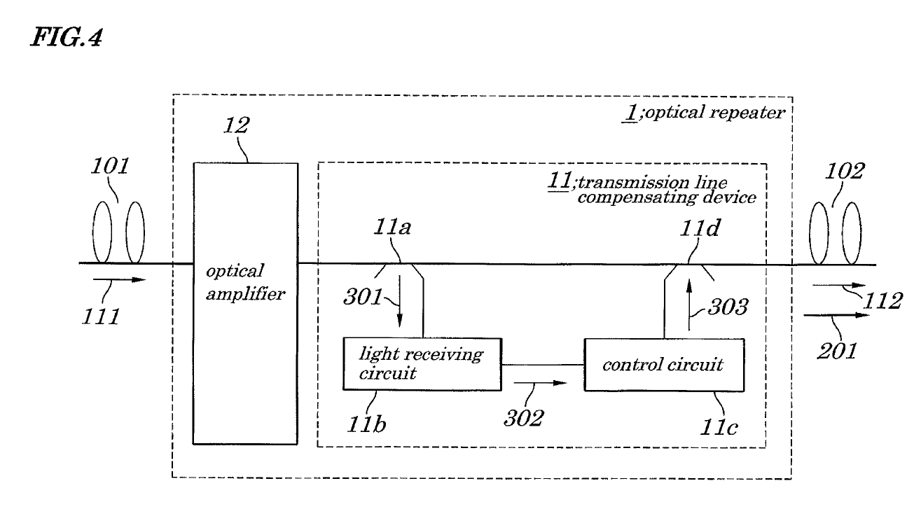

FIG. 4 is a schematic block diagram showing detailed configurations of an optical repeater 1 according to a second embodiment. As shown in FIG. 4, the optical repeater 1 is composed of a transmission line compensating device 11 and an optical amplifier 12; and the transmission line compensating device 11 is provided with an optical branching circuit 11a, a light receiving circuit 11b, a control circuit 11c and an optical multiplexer 11d. Unlike in a case of the first embodiment, in the second embodiment, a control signal 201 is sent to an optical transmission line 102 disposed at a back stage in the optical repeater 1. That is, an optical signal 111 propagating through an optical transmission line 101 is amplified by the optical amplifier 12 and then a part of the amplified optical signal is branched by the optical branching circuit 11a in the line transmission line compensating device 11 of the optical repeater 1 and a branched optical signal 301 is received by the light receiving circuit 11b. On the branched optical signal 301 is superimposed a control signal 302 which controls operations of the control circuit 11c. The control circuit 11c emits a control light 303 in response to the control signal 302. The control light 303 is emitted as the control light 201 to the optical transmission line 102 by the optical multiplexer 11d in the transmission line compensating device 11. By the control signal 201, a Raman amplification effect causes in the optical transmission line 102 and a loss spectrum in a wavelength band of an optical signal 112 is compensated.

### Third Embodiment

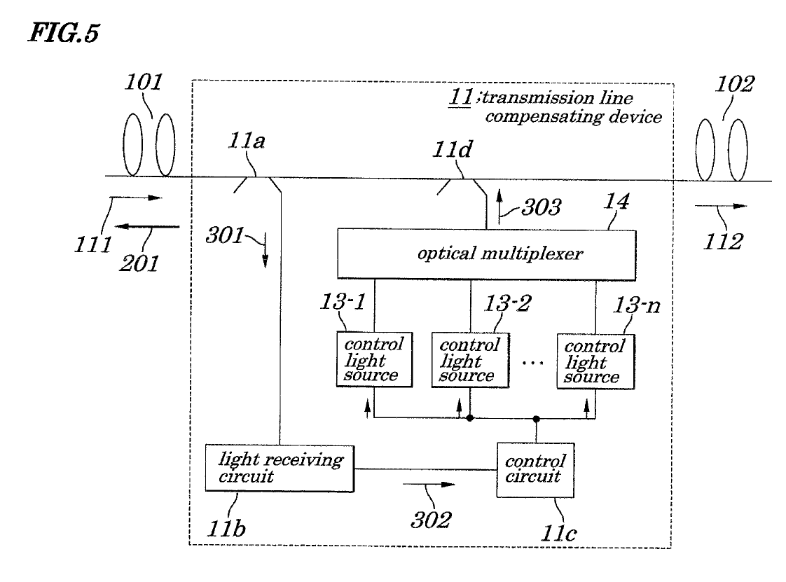

FIG. 5 is a schematic block diagram showing detailed configurations of a transmission line compensating device 11 according to a third embodiment of the present invention. The transmission line compensating device 11 is composed of an optical branching circuit 11a, a light receiving circuit 11b, a control circuit 11c, optical multiplexers 11d and 14 and control light sources 13-1 to 13-n. The control circuit 11c includes a plurality of the control light sources 13-1 to 13-n from which have a control light with a different wavelength and output and emits a plural of control lights with a different wavelength and output in response to the control signal 302.

The control light emitted from each of the control light sources 13-1 to 13-n is multiplexed by the optical multiplexer 14 and is transmitted as control light 201 to an optical transmission line 101 by the optical multiplexer 11d. Control light 201 causes a Raman amplification effect in the optical transmission line 101 which compensates a loss spectrum exhibited intrinsically by the optical transmission line 101 in a wavelength band of an optical signal 111.

### Fourth Embodiment

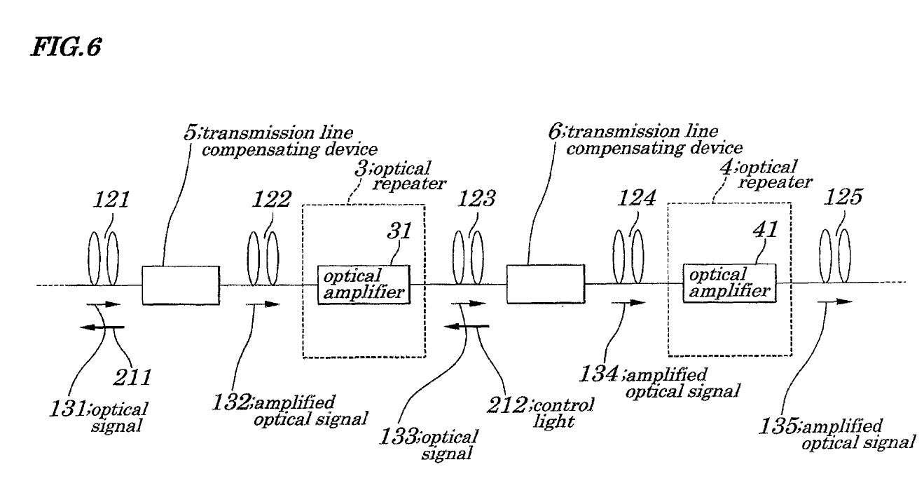

FIG. 6 is a schematic block diagram showing configurations of an optical communication system according to a fourth embodiment of the present invention. As shown in FIG. 6, in the optical communication system of the fourth embodiment, between an optical transmission line 121 and an optical transmission line 123 and between an optical transmission line 124 and an optical transmission line 125 are disposed an optical repeater 3 and an optical repeater 4 respectively. Between the optical transmission line 121 and between an optical transmission line 122 and between the optical transmission line 123 and the optical transmission line 124 are separately and individually disposed a transmission line compensating device 5 and a transmission line compensating device 6 respectively. The optical repeater 3 has an optical amplifier 31 and the optical repeater 4 has an optical amplifier 41. An optical signal 132 propagates through the optical transmission line 122 and is then amplified by the optical amplifier 31 in the optical repeater 3 and further propagates as an amplified optical signal 134 through the optical transmission line 123. Similarly, the optical signal 134 propagates through the optical transmission line 124 and is then amplified by the optical amplifier 41 in the optical repeater 4 and further propagates as an amplified optical signal 135 through the optical transmission line 123. The transmission line compensating device 5 emits a control light 211, based on a control signal superimposed on the optical signal 131, to the optical transmission line 121. The transmission line compensating device 6 emits a control light 212, based on a control signal superimposed on an optical signal 133, to the optical transmission line 123. Control light 211 causes a Raman amplification effect in the optical transmission line 121 causing a loss spectrum exhibited intrinsically by the optical transmission line 121 to be compensated in a wavelength band of the optical signal 121. Control light 212 causes a Raman amplification effect in the optical transmission line 123 causing a loss spectrum exhibited intrinsically by the optical transmission line 123 to be compensated in a wavelength band of the optical signal 123.

### Fifth Embodiment

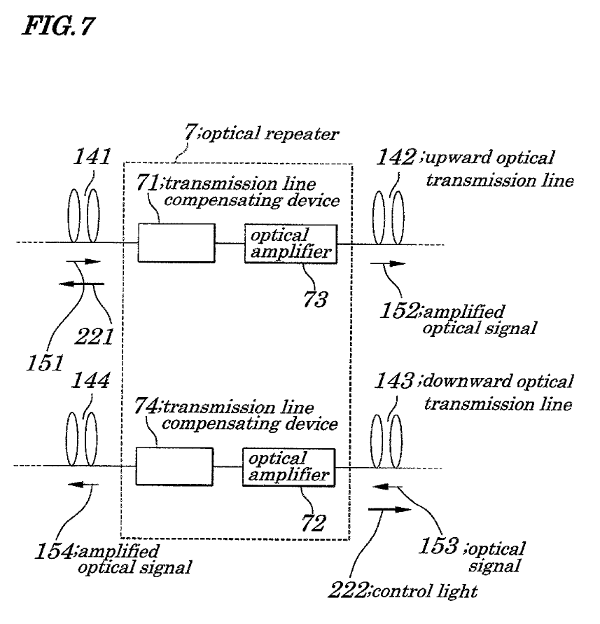

FIG. 7 is a schematic block diagram showing detailed configurations of an optical repeater 7 according to a fifth embodiment of the present invention. As shown in FIG. 7, the optical repeater 7 is composed of a transmission line compensating device 71 and a transmission line compensating device 72 and of an optical amplifier 73 and an optical amplifier 74. The transmission line compensating device 71 and the optical amplifier 73 are individually disposed which are adapted to serve an upward optical transmission line 141 and an upward optical transmission line 142 only while the transmission line compensating device 72 and the optical amplifier 74 are individually disposed which are adapted to serve a downward optical transmission line 143 and an downward optical transmission line 144 only.

An optical signal 151 propagates through the upward optical transmission line 141 and is then amplified by the optical amplifier 73 in the optical repeater 7 and further propagates as an amplified optical signal 152 through the upward optical transmission line 142. Similarly, an optical signal 153 propagates through the downward optical transmission line 143 and is then amplified by the optical amplifier 74 in the optical repeater 7 and further propagates as an amplified optical signal 154 through the downward optical transmission line 144.

The transmission line compensating device 71 emits a control light 221, based on a control signal superimposed on the optical signal 151 propagating through the upward optical transmission line 141, to the upward optical transmission line 141. Control light 221 causes a Raman amplification effect in the upward optical transmission line 141 causing a loss spectrum exhibited intrinsically by the upward optical transmission line 141 to be compensated in a wavelength band of the optical signal 151. Similarly, the transmission line compensating device 72 emits a control light 222, based on a control signal superimposed on the optical signal 153 which has propagated through the downward optical transmission line 143, to the downward optical transmission line 143. Control light 222 causes a Raman amplification effect in the downward optical transmission line 143 causing a loss spectrum exhibited intrinsically by the downward optical transmission line 143 to be compensated in a wavelength band of the optical signal 153.

### Sixth Embodiment

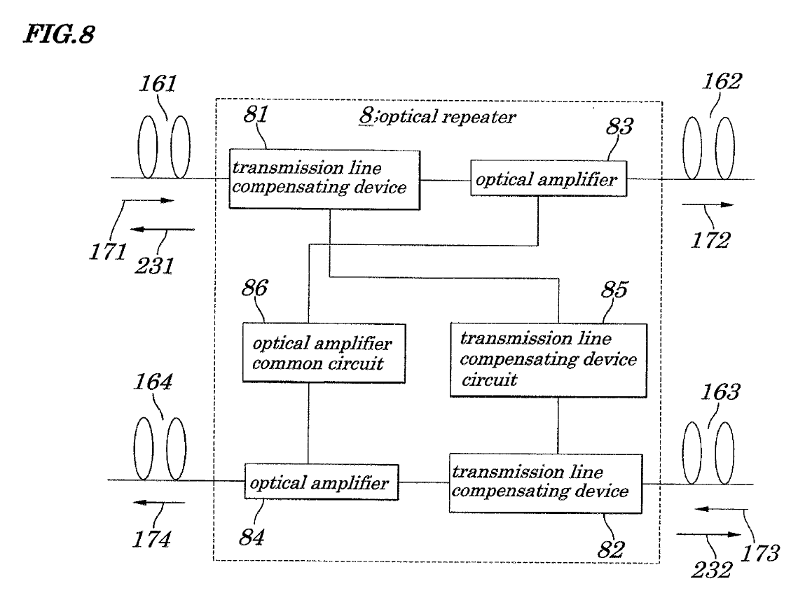

FIG. 8 is a schematic block diagram showing detailed configurations of an optical repeater 8 according to a sixth embodiment of the present invention. As shown in FIG. 8, The optical repeater 8 is composed of a transmission line compensating device 81 and a transmission line compensating device 82, an optical amplifier 83 and an optical amplifier 84, a transmission line compensating device common circuit 85 and an optical amplifier common circuit 86. In the sixth embodiment, the transmission line compensating device circuit 85 is newly mounted which is adapted to be used commonly for an upward optical transmission line 161 and an upward optical transmission line 162 and for a downward optical transmission line 163 and a downward optical transmission line 164, while the optical amplifier common circuit 86 is newly mounted which is adapted to be used commonly for the upward optical transmission lines 161 and 162 and for downward optical transmission lines 163 and 164.

An optical signal 171 propagates through the upward optical transmission line 161 and is then amplified by the optical amplifier 83 in the optical repeater 8 and further propagates as an amplified optical signal 172 through the upward optical transmission line 162. Similarly, an optical signal 173 propagates through the downward optical transmission line 163 and is then amplified by the optical amplifier 84 in the optical repeater 8 and further propagates as an amplified optical signal 174 through the downward optical transmission line 164. The transmission line compensating device 81 emits a control light 231, based on a control signal superimposed on the optical signal 171 which has propagated through the upward optical transmission line 161, to the upward optical transmission line 161. Control light 231 causes a Raman amplification effect in the upward optical transmission line 161 causing a loss spectrum exhibited intrinsically by the upward optical transmission line 161 to be compensated in a wavelength band of the optical signal 171. Similarly, the transmission line compensating device 82 emits a control light 232, based on a control signal superimposed on the optical signal 173 which has propagated through the downward optical transmission line 163, to the downward optical transmission line 163. Control light 232 causes the Raman amplification effect in the downward optical transmission line 163 causing a loss spectrum exhibited intrinsically by the downward optical transmission line 163 to be compensated in a wavelength band of the optical signal 173.

Moreover, though, in an optical repeater of the fifth embodiment, pumping sources and driving circuits to drive the pumping sources adapted to control each of transmission line compensating device 71 and a transmission line compensating device 72 and each of optical amplifiers are individually mounted on each of the upward optical transmission lines 161, 162 and downward optical transmission lines 163, 164 in the optical repeater 8 of the sixth embodiment, such the pumping sources and driving circuits are not provided to each of the upward optical transmission line or downward optical transmission line but mounted within the transmission line compensating device common circuit 85 and the optical amplifier common circuit 86 so that they can be used commonly and can control simultaneously both the upward optical transmission line and downward optical transmission line. Thus, by compensating a loss spectrum exhibited intrinsically by an optical transmission line using control light 201, 202, 212, 221, 222, 231 and 232 emitted from the transmission line compensating devices mounted inside the optical repeaters 1, 2, 7 and 8 and the transmission line compensating devices 5 and 6 mounted outside the optical repeaters 3 and 4, easy calibration of a difference in outputs of each of wavelength-multiplexed signals can be achieved.

As described above, in an optical communication system in which an optical signal propagating through an optical transmission line is amplified by an optical amplifier in an optical repeater and is then sent to an optical transmission line mounted at a back stage, by being provided with a transmission line compensating device adapted to generate, based on a control signal superimposed on the optical signal, control light which produces a Raman amplification effect in the optical transmission line, a difference in outputs of each of wavelength-multiplexed signals can be easily calibrated.

It is apparent that the present invention is not limited to the above embodiments but may be changed and modified without departing from the scope and spirit of the invention. For example, each of the configurations disclosed in the above first to sixth embodiments may be employed in various combinations to implement the present invention.

What is claimed is:

1. An optical communication system for amplifying an optical signal propagating through an optical transmission line by using an optical amplifier in an optical repeater and emitting an amplified optical signal to an optical transmission line mounted at a back stage comprising:
a transmission line compensating device to generate control light for producing a Raman amplification effect within said optical transmission line based on a control signal superimposed on said optical signal.

2. The optical communication system according to claim 1, wherein said transmission line compensating device is so configured as to send said control light to an optical transmission line mounted at a front stage.

3. The optical communication system according to claim 1, wherein said transmission line compensating device is so configured as to send said control light to said optical transmission line mounted at said back stage.

4. The optical communication system according to claim 1, wherein said transmission line compensating device is mounted inside said optical repeater.

5. The optical communication system according to claim 1, wherein said transmission line compensating device is separately and individually outside said optical repeater.

6. The optical communication system according to claim 1, wherein said transmission line compensating device includes two or more control light sources to generate control light having a different wavelength and output and an optical multiplexer to multiplex said control light fed from said two or more control light sources.

7. An optical communication system for amplifying an optical signal propagating through an upward transmission line or a downward transmission line by using a corresponding optical amplifier in an optical repeater and sending an amplified optical signal to an upward transmission line or a downward transmission line mounted at a back stage comprising:
transmission line compensating devices each operating for said upward transmission line or said downward transmission line and each generating, based on a control signal superimposed on said optical signal, control light which causes a Raman amplification effect in said optical transmission lines.

8. The optical communication system according to claim 7, wherein said transmission line compensating devices are so configured as to send said control light to optical transmission lines mounted at a front stage.

9. The optical communication system according to claim 7, wherein said transmission line compensating devices are so configured as to send said control light to said optical transmission lines mounted at said back stage.

10. The optical communication system according to claim 7, wherein said transmission line compensating devices are mounted inside said optical repeater.

11. The optical communication system according to claim 7, wherein said transmission line compensating devices are separately and individually mounted outside said optical repeater.

12. The optical communication system according to claim 7, wherein said transmission line compensating devices include two or more control light sources to generate control light having a different wavelength and output and an optical multiplexer to multiplex said control light fed from said two or more control light sources.

13. The optical communication system according to claim 7, further comprising common circuits each controlling simultaneously said transmission line compensating devices each operating to correspond to said upward transmission line or said downward transmission line.

14. An optical repeater for amplifying an optical signal propagating through an optical transmission line by using an optical amplifier and sending an amplified optical signal to an optical transmission line mounted at a back stage comprising:
a transmission line compensating device to generate, based on a control signal superimposed on said optical signal, control light which causes a Raman amplification effect within said optical transmission line.

15. The optical repeater according to claim 14, wherein said transmission line compensating device is so configured as to send said control light to an optical transmission line mounted at a front stage.

16. The optical repeater according to claim 14, wherein said transmission line compensating device is so configured as to send said control light to said optical transmission line mounted at a back stage.

17. The optical repeater according to claim 14, wherein said transmission line compensating device is mounted inside said optical repeater.

18. The optical repeater according to claim 14, wherein said transmission line compensating device is separately and individually mounted outside said optical repeater.

19. The optical repeater according to claim 14, said transmission line compensating device includes two or more control sources to generate control light having a different wavelength and output and an optical multiplexer to multiplex said control light fed from said two or more control light sources.

20. An optical repeater for amplifying an optical signal propagating through an upward transmission line or a downward transmission line by using a corresponding optical amplifier and sending an amplified optical signal to an upward transmission line mounted at a back stage or a downward transmission line mounted at a back stage comprising:
transmission line compensating devices each operating for said upward transmission line or said downward transmission line and each generating, based on a control signal superimposed on said optical signal, control light which produces a Raman amplification effect within said upward transmission line or said downward transmission line.

21. The optical repeater according to claim 20, wherein said transmission line compensating devices are so configured as to send said control light to an optical transmission line mounted at a front stage.

22. The optical repeater according to claim 20, wherein said transmission line compensating devices are so configured as to send said control light to said optical transmission line mounted at said back stage.

23. The optical repeater according to claim 20, wherein said transmission line compensating devices are mounted inside said optical repeater.

24. The optical repeater according to claim 20, wherein said transmission line compensating devices are separately and individually mounted outside said optical repeater.

25. The optical repeater according to claim 20, said transmission line compensating devices includes two or more control sources to generate control light having a different wavelength and output and an optical multiplexer to multiplex said control light fed from said two or more control light sources.

26. The optical repeater according to claim 20, further comprising common circuits each controlling simultaneously said transmission line compensating devices each operating to correspond to said upward transmission line or said downward transmission line.
